(19) United States
(12) Patent Application Publication
(10) Pub. No.: US 2014/0145052 A1
(43) Pub. Date: May 29, 2014

(54) RESILENT SUPPORT DEVICE FOR ELECTRIC FACILITY

(71) Applicant: Chih Feng HO, Taipei (TW)

(72) Inventor: Chih Feng HO, Taipei (TW)

(21) Appl. No.: 13/687,173

(22) Filed: Nov. 28, 2012

(51) Int. Cl. F16M 13/00

(52) U.S. Cl. CPC F16M 13/00
USPC 248/299.1

(57) ABSTRACT

A resilient support device includes a lever having a lower portion pivotally coupled to a supporting seat and an upper portion pivotally coupled to an object with a coupler, a sustaining device includes a sustaining member having a bottom portion engaged into and through a slot of the supporting seat, a middle segment tilted and inclined relative to the bottom portion of the sustaining member and engaged with the lever for providing a sustaining force to the lever, and an upper segment engaged with the coupler for supporting the coupler on the upper portion of the lever. The sustaining device includes one or more blades attached to the seat and engaged with the sustaining member for sustaining the sustaining member.

### BACKGROUND OF THE INVENTION

1. Field of the Invention

The present invention relates to a resilient or adjustable support device for supporting object or electric facility, such as monitor, keyboard, antenna member, or displayer or the like, and more particularly to a resilient support device including a resilient structure or mechanism for suitably and stably and solidly attaching or mounting or supporting the object, the monitor, the keyboard, the antenna member, or the displayer or the like thereon.

2. Description of the Prior Art

Various kinds of typical adjustable support devices have been developed and comprise a support member or carrier member attached or mounted to a supporting stand and for supporting various objects or electric facilities, such as monitors, displays, keyboards, antenna members, or the like.

For example, U.S. Pat. No. 4,834,329 to Delapp, U.S. Pat. No. 5,037,054 to McConnell, U.S. Pat. No. 5,123,621 to Gates, U.S. Pat. No. 5,553,820 to Karten et al., U.S. Pat. No. 5,713,549 to Shieh, U.S. Pat. No. 6,213,438 to Ostby et al., U.S. Pat. No. 6,766,994 to Serbinski et al., U.S. Pat. No. 6,796,537 to Lin, U.S. Pat. No. 6,863,252 to Bosson, U.S. Pat. No. 7,413,152 to Chen, U.S. Pat. No. 7,628,552 to Coppola, U.S. Pat. No. 7,644,897 to Shin, U.S. Pat. No. 7,722,003 to Ishizaki et al., and U.S. Pat. No. 7,784,747 to Gan et al. disclose several of the typical support devices or carrier devices each also comprising a support member or carrier member pivotally or rotatably attached or mounted or coupled to a supporting stand with one or more pivotal arms for supporting various objects, such as monitors, displays, keyboards, antenna members, or the like.

However, normally, the support members or carrier members and the pivotal arms and the supporting stands include a rather complicated structure or configuration and are pivotally or rotatably coupled together with pivot joints or axles and are adjustable to different angular positions by a frictional force between the members or elements, such that the frictional coupling portions between the members or elements will be easily worn out or damaged after use.

The present invention has arisen to mitigate and/or obviate the afore-described disadvantages of the conventional adjustable support devices.

### SUMMARY OF THE INVENTION

The primary objective of the present invention is to provide a resilient support device including a resilient or biasing structure or mechanism for suitably and stably and solidly attaching or mounting or supporting the object or the electric facility, such as the monitor, the keyboard, the antenna member, or the displayer or the like thereon.

In accordance with one aspect of the invention, there is provided a support device comprising a supporting seat including a slot formed therein, an object, a lever including a lower portion pivotally coupled to the supporting seat, and including an upper portion, a coupler pivotally coupled to the upper portion of the lever and attached to the object for pivotally coupling and supporting the object on the upper portion of the lever with the coupler, and a sustaining device including a sustaining member having a bottom portion engaged into and through the slot of the supporting seat, and the sustaining member including a body segment tilted and inclined relative to the bottom portion of the sustaining member and contacted and engaged with the lever for providing a sustaining force to the lever and the object, and including an upper segment engaged with the coupler for supporting the coupler and the object on the upper portion of the lever.

The lever includes an opening formed in the upper portion of the lever for attaching the coupler. The lever includes an aperture formed in the upper portion of the lever and communicating with the opening of the lever, and the coupler includes a pivot shaft extended laterally and outwardly from the coupler for engaging with the aperture of the lever and for rotatably attaching the coupler to the lever.

The lever includes a notch formed in the lower portion of the lever for pivotally engaging with the supporting seat and for allowing the lever to be pivoted or rotated relative to the supporting seat.

The lever includes an orifice formed in the lower portion of the lever and communicating with the notch of the lever, and the supporting seat includes a beam attached to the supporting seat, and the beam includes two end portions extended out of the supporting seat and engaged into the orifice of the lever.

The supporting seat includes a chamber formed therein and formed or defined by two side panels, and the two end portions of the beam are engaged through the side panels of the supporting seat and engaged into the orifice of the lever.

The supporting seat includes a bottom panel and a rear panel to form the chamber of the supporting seat together with the side panels of the supporting seat, and the slot of the supporting seat is formed between the bottom panel and the rear panel of the supporting seat.

The supporting seat includes a non-circular orifice formed in each of the side panels, and the beam includes a non-circular cross section engaged the non-circular orifices of the side panels for preventing the beam from being rotated relative to the side panels of the supporting seat.

The upper segment of the sustaining member is tilted and inclined relative to the body segment of the sustaining member, and includes a depression formed in the upper segment of the sustaining member for engaging with the coupler.

The lever includes a compartment formed therein and defined between two parallel walls, and the sustaining member is engaged in the compartment of the lever and contacted and engaged with the lever.

The supporting seat includes a beam attached to the supporting seat, and the sustaining device includes a first blade attached to the beam and contacted and engaged with the sustaining member for providing a sustaining force to the sustaining member.

The first blade includes a bottom portion secured to the beam and includes a blade element tilted and inclined relative to the bottom portion of the first blade and contacted and engaged with the sustaining member. The sustaining device includes a second blade attached to the beam and contacted and engaged with the first blade.

The second blade includes a bottom portion secured to the beam and includes a blade element tilted and inclined relative to the bottom portion of the second blade and contacted and engaged with the first blade. The second blade includes a length different from that of the first blade.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a rear perspective view of a resilient support device in accordance with the present invention;

FIG. 2 is a partial exploded view of the resilient support device;

FIG. 3 is a partial side plan schematic view of the resilient support device;

FIG. 4 is a partial side plan schematic view similar to FIG. 3, illustrating the operation of the resilient support device;

FIG. 5 is a front perspective view of the resilient support device; and

FIG. 6 is an exploded view of the resilient support device.

### DETAILED DESCRIPTION OF THE PREFERRED EMBODIMENT

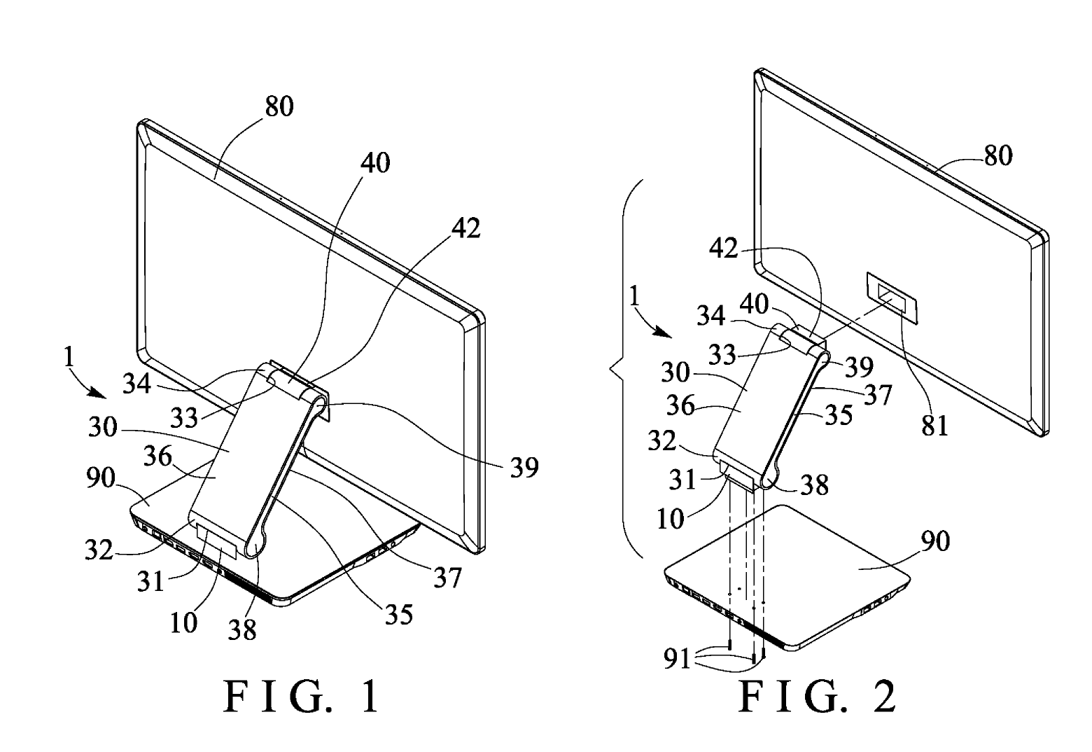

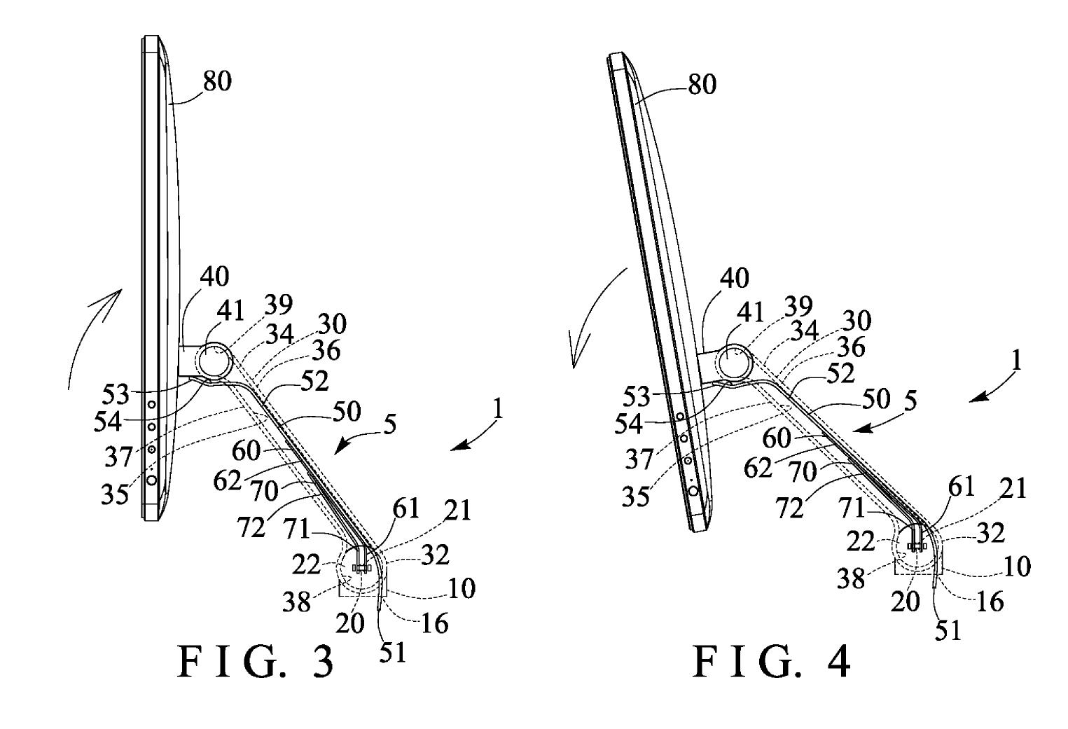

Referring to the drawings, and initially to FIGS. 1-5, a resilient support device 1 in accordance with the present invention is provided for carrying or sustaining or supporting an object 80, such as an electric or computer facility 80, a monitor, a keyboard, an antenna member, a displayer device or the like on a supporting surface or member or table 90 or the like, and the resilient support device 1 comprises a supporting stand or base or seat 10 including a chamber 11 formed therein and formed or defined by a base or bottom wall or panel 12, two side walls or panels 13, 14, and a rear wall or panel 15, in which the side walls or panels 13, 14 are preferably parallel to each other, and the rear wall or panel 15 is attached or mounted or secured or coupled between the side walls or panels 13, 14 and separated or spaced from the bottom wall or panel 12 for forming or defining a groove or slot 16 between the bottom wall or panel 12 and the rear wall or panel 15 (FIGS. 3, 4, 6).

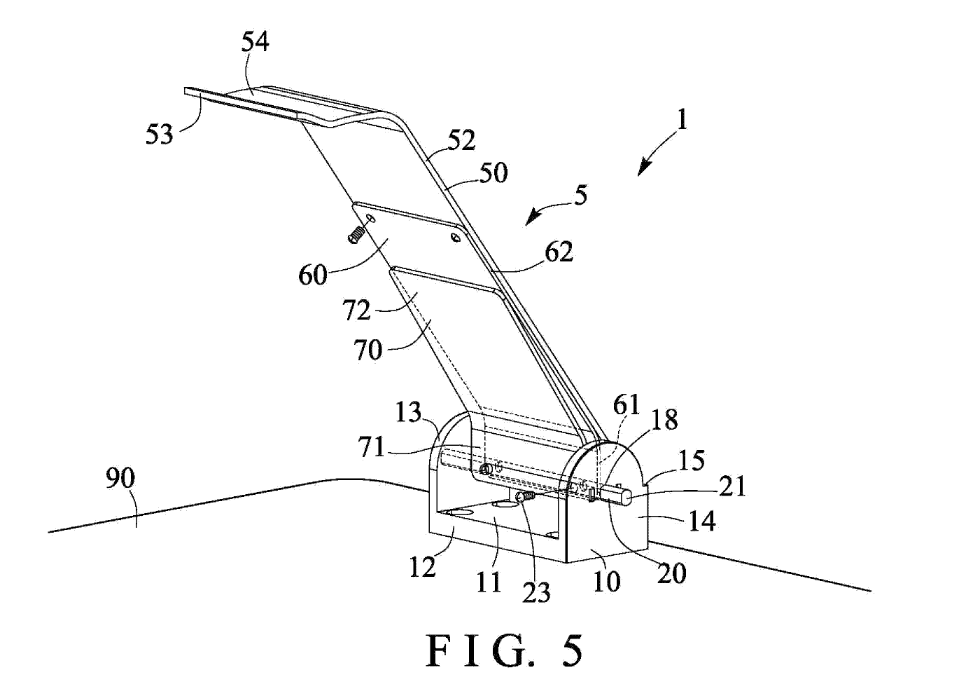

As shown in FIGS. 1-2 and 5, the bottom wall or panel 12 of the supporting seat 10 may be attached or mounted or secured to the supporting table 90 with latches or lock mechanisms or fasteners 91 (FIG. 2), and the supporting seat 10 includes an orifice 17, 18 formed in each of the side panels 13, 14 and having a non-circular cross section for receiving or engaging with a rod or lever or beam 20 which also includes a non-circular cross section identical or similar to or corresponding to that of the orifices 17, 18 of the side panels 13, 14 for preventing the beam 20 from being pivoted or rotated relative to the side panels 13, 14 of the supporting seat 10, and the beam 20 is engaged through the side panels 13, 14 of the supporting seat 10 and is longer than the supporting seat 10 and includes two end portions 21 extended out of the side panels 13, 14 of the supporting seat 10 (FIG. 5) for pivotally or rotatably attaching or mounting or securing or coupling to an arm or beam or rod or lever 30.

As shown in FIGS. 1-4 and 6, the arm or beam or rod or lever 30 includes a depression or recess or opening or notch 31 formed therein, such as formed in the lower or bottom portion 32 thereof for receiving or engaging with the supporting seat 10 and arranged for allowing the lever 30 to be pivoted or rotated relative to the supporting seat 10, and the lever 30 further includes another notch or depression or recess or opening 33 formed therein, such as formed in the upper portion 34 thereof for pivotally or rotatably attaching or mounting or securing or coupling or supporting the object or electric or computer facility 80. The lever 30 further includes an oblong or longitudinal compartment 35 formed therein, and formed or defined by or between two parallel walls 36, 37 for forming or defining a spatial or three-dimension structure or configuration for the lever 30 and for suitably increasing the bending strength for the lever 30 and for allowing the lever 30 to suitably sustain or support the object or electric or computer facility 80 on the supporting seat 10 and the supporting table 90.

The lever 30 further includes an opening or bore or aperture or orifice 38 formed therein, such as formed in the lower or bottom portion 32 thereof and communicating with the compartment 35 of the lever 30 and intersecting or communicating with the notch 31 of the lever 30, and preferably having a circular cross section for receiving or engaging with the two end portions 21 of the beam 20, in which the two end portions 21 of the beam 20 may be coupled to or engaged with or attached or mounted to the lower or bottom portion 32 of the lever 30 with bearing members or plugs or caps or lids or blocks 22 (FIGS. 3, 4), and arranged for allowing the lever 30 to be pivoted or rotated relative to the two end portions 21 of the beam 20. The lever 30 further includes an opening or bore or orifice or aperture 39 formed therein, such as formed in the upper portion 34 thereof and communicating with the compartment 35 of the lever 30 and intersecting or communicating with the opening 33 of the lever 30, and preferably having a circular cross section.

A coupler 40 is received or engaged in the opening 33 of the lever 30 and includes a pivot shaft 41 extended laterally and outwardly therefrom for engaging with the aperture 39 of the lever 30 (FIGS. 3, 4) and for pivotally or rotatably attaching or mounting or securing or coupling or positioning the coupler 40 to the lever 30 and for allowing the coupler 40 to be pivoted or rotated relative to the lever 30, and the coupler 40 includes a projection or protrusion or extension 42 extended outwardly therefrom for engaging with a hole or slot or groove 81 of the object or electric or computer facility 80 (FIG. 2) and for attaching or mounting or securing or coupling the coupler 40 to the object or electric or computer facility 80 (FIGS. 1, 3, 4) and thus for allowing the object or electric or computer facility 80 to be suitably and pivotally or rotatably attached or mounted or secured or coupled to or supported on the lever 30 with the coupler 40 and for allowing the object or electric or computer facility 80 to be pivoted or rotated or adjusted relative to the lever 30 and the supporting seat 10 to the selected or suitable angular positions (FIGS. 3, 4).

A primary spring biasing member or anchoring or retaining or positioning or sustaining device 5 includes a sustaining member 50 having an oblong or longitudinal or planar structure or configuration and having a lower or bottom end portion 51 engaged into or through the slot 16 that is formed or defined by or between the bottom wall or panel 12 and the rear wall or panel 15 of the supporting seat 10 (FIGS. 3, 4), and anchored or retained or attached or mounted or secured or fastened to the supporting seat 10 with adhesive materials, welding procedures, latches or fasteners (not shown) or the like, and the sustaining member 50 includes a middle or intermediate or primary or body segment 52 tilted or inclined or bent relative to the lower or bottom end portion 51 of the sustaining member 50, and includes an upper segment 53 tilted or inclined or bent relative to the middle or intermediate or body segment 52 and having a cavity or recess or depression 54 formed therein for receiving or engaging with the coupler 40 and thus for suitably supporting the coupler 40 and the object or electric or computer facility 80 on the upper portion 34 of the lever 30, best shown in FIGS. 3 and 4.

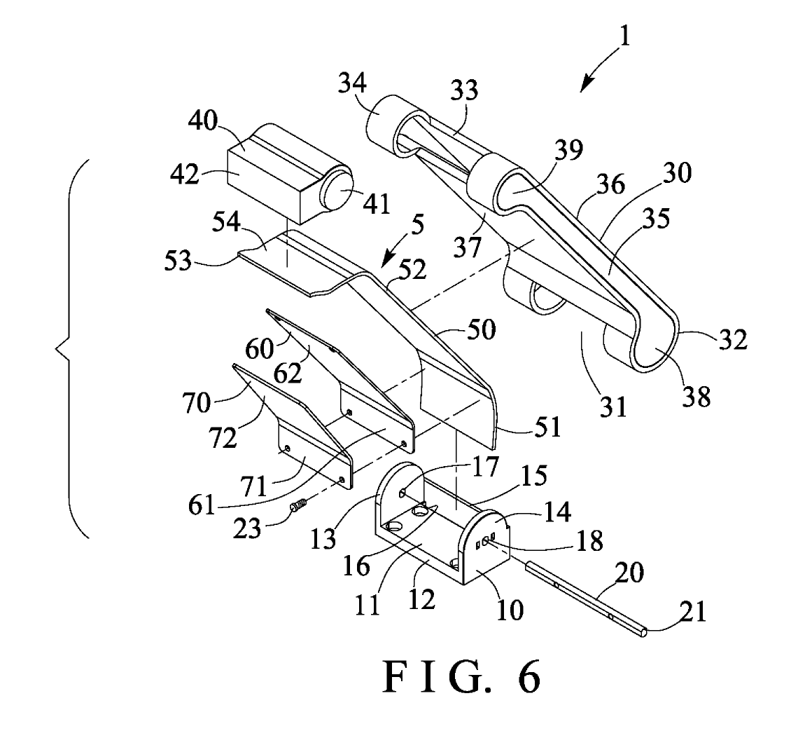

The sustaining member 50, particularly the middle or intermediate or body segment 52 of the sustaining member 50 is received or engaged in the compartment 35 of the lever 30 and contacted or engaged with the lever 30 for providing a spring and resilient or anchoring or retaining or sustaining force to the lever 30 and the coupler 40 and the object or electric or computer facility 80. The sustaining device 5 further includes one or more (such as two) spring biasing members or spring blades 60, 70 each having a lower or bottom end portion 61, 71 contacted or engaged with the beam 20 and attached or mounted or secured to the beam 20 with adhesive materials, welding procedures, latches or fasteners 23 (FIGS. 5, 6) or the like, and the first and the second spring blades 60, 70 each include a body or blade element 62, 72 tilted or inclined or bent relative to the lower or bottom end portion 61, 71 thereof and contacted or engaged with the sustaining member 50, particularly the middle or intermediate segment 52 of the sustaining member 50 for further providing a spring and resilient or anchoring or retaining or sustaining force to the sustaining member 50 and the lever 30 and the object or electric or computer facility 80.

As best shown in FIGS. 3-6, the spring blades 60, 70 include a length different from each other, for example, the spring blade 60 includes a length greater than that of the other spring blade 70, but smaller than that of the sustaining member 50 for allowing the sustaining member 50 and the spring blades 60, 70 to suitably provide the spring and resilient or anchoring or retaining or sustaining force to the sustaining member 50 and the lever 30 and the object or electric or computer facility 80, and to suitably sustain or support the object or electric or computer facility 80 on the supporting seat 10 and the supporting table 90 with the lever 30 and the sustaining member 50 and the spring blades 60, 70 of the sustaining device 5. The thickness and/or the length and/or the width and/or the materials of the sustaining member 50 and the spring blades 60, 70 of the sustaining device 5 may be selected or changed according to the weight or size or dimension of the object or electric or computer facility 80.

In operation, as shown in FIGS. 1-4, the object or electric or computer facility 80 may be easily and quickly and readily attached or mounted or secured to the lever 30 with the coupler 40 and may be tilted or inclined or adjusted relative to the lever 30 and the supporting seat 10 to the selected or suitable angular positions. The supporting seat 10 and the lever 30 and the sustaining member 50 and the spring blades 60, 70 of the sustaining device 5 of the resilient support device 1 includes a simplified and compact and strong structure or configuration that may be easily and quickly manufactured and assembled with a greatly reduced or decreased manufacturing coat, and that may provide a suitably spring and resilient or anchoring or retaining or sustaining force to the lever 30 and the object or electric or computer facility 80, and to suitably sustain or support the object or electric or computer facility 80 on the supporting seat 10 and the supporting table 90 with the lever 30 and the sustaining member 50 and the spring blades 60, 70 of the sustaining device 5 of the resilient support device 1.

Accordingly, the resilient support device in accordance with the present invention includes a resilient or biasing structure or mechanism for suitably and stably and solidly attaching or mounting or supporting the object or the electric facility, such as the monitor, the keyboard, the antenna member, or the displayer or the like thereon.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A support device comprising:
a supporting seat including a slot formed therein,
an object,
a lever including a lower portion pivotally coupled to said supporting seat, and including an upper portion,
a coupler pivotally coupled to said upper portion of said lever and attached to said object for pivotally coupling and supporting said object on said upper portion of said lever with said coupler, and
a sustaining device including a sustaining member having a bottom portion engaged into and through said slot of said supporting seat, and said sustaining member including a body segment tilted and inclined relative to said bottom portion of said sustaining member and contacted and engaged with said lever for providing a sustaining force to said lever and said object, and including an upper segment engaged with said coupler for supporting said coupler and said object on said upper portion of said lever.

2. The support device as claimed in claim 1, wherein said lever includes an opening formed in said upper portion of said lever for attaching said coupler.

3. The support device as claimed in claim 2, wherein said lever includes an aperture formed in said upper portion of said lever and communicating with said opening of said lever, and said coupler includes a pivot shaft extended laterally and outwardly from said coupler for engaging with said aperture of said lever and for rotatably attaching said coupler to said lever.

4. The support device as claimed in claim 1, wherein said lever includes a notch formed in said lower portion of said lever for pivotally engaging with said supporting seat and for allowing said lever to be rotated relative to said supporting seat.

5. The support device as claimed in claim 4, wherein said lever includes an orifice formed in said lower portion of said lever and communicating with said notch of said lever, and said supporting seat includes a beam attached to said supporting seat, and said beam includes two end portions extended out of said supporting seat and engaged into said orifice of said lever.

6. The support device as claimed in claim 5, wherein said supporting seat includes a chamber formed therein and defined by two side panels, and said two end portions of said beam are engaged through said side panels of said supporting seat.

7. The support device as claimed in claim 6, wherein said supporting seat includes a bottom panel and a rear panel to form said chamber of said supporting seat together with said side panels of said supporting seat, and said slot of said supporting seat is formed between said bottom panel and said rear panel of said supporting seat.

8. The support device as claimed in claim 6, wherein said supporting seat includes a non-circular orifice formed in each of said side panels, and said beam includes a non-circular cross section engaged said non-circular orifices of said side panels for preventing said beam from being rotated relative to said side panels of said supporting seat.

9. The support device as claimed in claim 1, wherein said upper segment of said sustaining member is tilted and inclined relative to said body segment of said sustaining member, and includes a depression formed in said upper segment of said sustaining member for engaging with said coupler.

10. The support device as claimed in claim 1, wherein said lever includes a compartment formed therein and defined between two parallel walls, and said sustaining member is engaged in said compartment of said lever.

11. The support device as claimed in claim 1, wherein said supporting seat includes a beam attached to said supporting seat, and said sustaining device includes a first blade attached to said beam and contacted and engaged with said sustaining member for providing a sustaining force to said sustaining member.

12. The support device as claimed in claim 11, wherein said first blade includes a bottom portion secured to said beam and includes a blade element tilted and inclined relative to said bottom portion of said first blade and contacted and engaged with said sustaining member.

13. The support device as claimed in claim 11, wherein said sustaining device includes a second blade attached to said beam and contacted and engaged with said first blade.

14. The support device as claimed in claim 13, wherein said second blade includes a bottom portion secured to said beam and includes a blade element tilted and inclined relative to said bottom portion of said second blade and contacted and engaged with said first blade.

15. The support device as claimed in claim 13, wherein said second blade includes a length different from that of said first blade.
